(19) United States
(12) Patent Application Publication
(10) Pub. No.: US 2015/0221905 A1
(43) Pub. Date: Aug. 6, 2015

(54) LITHIUM-ION BATTERY PACK FOR EASY INSTALLATION

(71) Applicant: Shenzhen Grepow Battery Co., Ltd, Shenzhen (CN)

(72) Inventors: Bing Guo, Shenzhen (CN); An'Xuan He, Shenzhen (CN); Bangsen Wu, Shenzhen (CN)

(73) Assignee: Shenzhen Grepow Battery Co., Ltd, Shenzhen (CN)

(21) Appl. No.: 14/418,363

(22) PCT Filed: Jul. 30, 2013
(86) PCT No.: PCT/CN2013/080394

§ 371 Date: Jan. 29, 2015

(30) Foreign Application Priority Data
Aug. 2, 2012 (CN) 201210273388.3

(51) Int. Cl. H01M 2/10; H01M 10/0525

(52) U.S. Cl. CPC H01M 2/1016; H01M 10/0525; H01M 2/1094; H01M 10/6551

(57) ABSTRACT

The present invention directs a lithium-ion battery pack which is easy to install comprises an cell and a case packaged outside the cell, wherein the cell is packaged in a side case, a bottom plate is packaged at the bottom of the side case, a top plastic part is fixed at the top of the side case, a plastic part rear cover plate is packaged to an opening portion of the side of the top plastic part, all shores of the top plastic part are inserted into the hole positions of the side case respectively, the bottom edge of the top plastic part is jointed with the edge of the top of the side case, an output interface part and an input interface part are installed at a internal position of a side of the top plastic part, which faces towards the opening portion of the side of the top plastic part, the output interface part and the input interface part are fixed on a patch board in a circuit mode respectively, the patch board is electrically connected to an input circuit and an output circuit of the cell respectively, all shores of the plastic part rear cover plate are inserted into the hole portions of the top plastic part respectively, and the plastic part rear cover plate is packaged on the opening portion of the side of the top plastic part.

### FIELD OF THE INVENTION

The present invention relates to the technical field of lithium-ion battery, and more particularly, to a lithium-ion battery pack for easy installation.

### BACKGROUND OF THE INVENTION

At present, the plastic case is always used for assembling the battery pack in the industrial application of lithium-ion battery pack, and the structure of such plastic case comprises a cover plate and a chamber with an opening at one side. When it is assembled, placing the cell in the chamber, and fixing the input and output circuits respectively on the chamber, the input/output circuits and the input/output interface parts are respectively electrically connected together; then, packaging the cover plate on the opening of the chamber.

During the research process of the present invention, the applicant found some defects in the prior art as given:

For the first, the installation of case with such above structure in the lithium-ion battery is a very complex process, especially the connection of input/output circuits located on the top of cell, which causes the low assembling efficiency and complex process.

In addition, when applying to a high rate battery pack which is discharged by a large current (the current reaches to 100˜200 A), such plastic case in the prior art cannot dissipate the heat efficiently since the temperature of battery pack is sharply increased during the battery pack is discharged by a large current during the use, and the produced heat has been stay in the plastic case, not dissipated as quickly as possible; however, if the battery pack is discharged by a large current in a long time, the lifetime of lithium-ion battery pack will be effected.

### SUMMARY OF THE INVENTION

One objective of the present invention is to provide a lithium-ion battery pack for easy installation.

As an embodiment of the present invention, a lithium-ion battery pack for easy installation comprising: a cell and a case packaged outside the cell;

The case comprises: a bottom plate, a side case, a top plastic part and a rear cover plate;

Two opposite ends of the side case are provided as opening, the cell is packaged in the side case, the bottom plate is packaged at the bottom of the side case, the top plastic part is fixed on the top of the side case, and the plastic part rear cover plate is packaged at the side opening part of the top plastic part;

At least one hole position is arranged on the top of the side case, at least a shore is arranged on the bottom of the top plastic part, each said shore of the top plastic part is respectively inserted into each said hole position of the side case, and the bottom edge of the top plastic part is jointed to the top edge of the side case;

On the top plastic part, an output interface part and an input interface part are arranged on the inner wall of the side plate which is directly faced to the side opening part of the top plastic part, said output interface part and input interface part are respectively circuit fixed on a patch board which is electrically connected to the input and output circuits of the cell; and

At least two extended shores are arranged on the plastic rear cover plate, and at least two horizontal hole parts are arranged on the top plastic part; each said shore of the plastic part rear cover plate is inserted into each said hole part of the top plastic part, and the plastic part rear cover plate is packaged on the side opening part of the top plastic part.

Optionally, a hole position is arranged at the top of four corner edges of the side case;

the shore is extended at each bottom of four corner edges of the top plastic part.

Optionally, there are six shores extended at the plastic part rear cover plate,

wherein four of said shores are located at edge corners of the plastic part rear cover plate, and the rest of said shores are located in the middle of two edges in the length direction of the rear cover plate;

there are six hole positions arranged in the plastic part rear cover plate.

Optionally, the side case is composed of a first snap-on side case and a second snap-on side case,

a side and two opposite ends of the first snap-on side case and the second snap-on side case are provided as opening,

the side opening part of the first snap-on side case and the second snap-on side case are directly faced to the snap-on connection;

the cell is packaged in the side case, which is in detailed as: the cell is packaged in a chamber formed between the first snap-on side case and the second snap-on side case.

Optionally, the slot-like openings of the first snap-on side case and the second snap-on side case are directly faced to the snap-on connection, which is in detailed as following:

a first snap-on part is arranged on both opening edges of slot-like opening of the first snap-on side case;

a second snap-on part is arranged on both opening edges of slot-like opening of the second snap-on side case,

the first snap-on part and the second snap-on part may be engaged to each other.

Optionally, each of the first snap-on part and the second snap-on part is continuously along the edge in length direction of the first snap-on side case and the second snap-on side case, whose length is the same as the edge in length direction.

Optionally, a first slot and a first ledge are respectively arranged on the outer surface of both side edges of the slot-like opening of the first snap-on side case, wherein on each side, the first ledge is located outside the first slot, and the first slot and the first ledge are composed the first snap-on part;

a second slot and a second ledge are respectively arranged on the inner side of both side edges of the slot-like opening of the second snap-on side case, wherein on each side, the second ledge is located outside the second slot, and the second slot and the second ledge are composed the second snap-on part;

the first ledge of the first snap-on side case is limited in the second slot of the second snap-on side case; and the second ledge of the second snap-on side case is limited in the first slot.

Optionally, a heat-dissipation ledge is provided on the outer surface of at least one side of the first snap-on side case and the second snap-on side case.

Optionally, the side case is a metal side case; and/ or

the bottom plate is a metal bottom plate.

Optionally, a horizontal bearing plate is arranged at inner side of the side plate directly faced to the side opening part on the top plastic part, and the output interface part and the input interface part are fixed on the upper surface of the horizontal bearing plate.

As described above, in the embodiment of the present invention, the case of battery pack comprises: a bottom plate, a side case, a top plastic part and a plastic part rear cover plate. With respect to a structure of the square chamber with plate in the prior art, it is more convenient for the installation of battery pack in the embodiment of present invention, which is beneficial to improve the efficiency of assembly technology during production.

In addition, in the embodiment, the side case is snap-on connected to the bottom of top plastic part via the hole positions and shores, and the top plastic part is snap-on connected to the plastic rear cover plate via the hole positions and shores for each part of the case can be assembled in a more convenient way, which is apt to positionable mounting, and further improving the assembly efficiency; additionally, it is avoided to produce scratches or defective products with the screw insertion by using of screw fastening.

Moreover, in the embodiment, the hole part is arranged in the length direction of the side case with a longer edge length, and arranged on the top plastic part with a longer edge length. It is beneficial for the arrangement of hole parts, and the hole parts are arranged to be more deeper so as to improve the adapted depth with the corresponding shores, which makes the connection of each part to be firmer and not easily displacing or falling apart.

Furthermore, in the embodiment, when it is assembled, after placing the cell in the chamber of the side case, the top of cell is connected through the top opening of the side case, and each monomer of the cell is circuit connected to the circuit, that is the series-parallel connection of each monomer, and the lead connection of input and output circuits; then, assembling the top plastic part on the top of cell, and the connection of circuit with each output/input interface part is presented through the side opening part of the top plastic part, so that the operation is more convenient and further improving the working efficiency.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an assembled structure of a lithium-ion battery pack for easy installation according to an embodiment of the present invention;

FIG. 2 is a partial enlarged schematic view of part 000 of the first snap-on side case 6021 in FIG. 1 according to an embodiment of the present invention;

FIG. 3 is a partial enlarged schematic view of part 111 of the first snap-on side case 6022 in FIG. 1 according to an embodiment of the present invention;

FIG. 4 is a stereostructure schematic view of the top plastic part 103 in FIG. 1 according to an embodiment of the present invention;

FIG. 5 is a stereostructure schematic view (in another angle) of the top plastic part 103 in FIG. 1 according to an embodiment of the present invention;

FIG. 6 is a front schematic view of the top plastic part 103 in FIG. 3 according to an embodiment of the present invention;

FIG. 7 is a back schematic view of the top plastic part 103 in FIG. 3 according to an embodiment of the present invention;

FIG. 8 is a stereostructure schematic view of the product of a lithium-ion battery pack for easy installation in FIG. 1 according to an embodiment of the present invention; and

FIG. 9 is another stereostructure schematic view of the product of a lithium-ion battery pack for easy installation in FIG. 1 according to an embodiment of the present invention.

### FIGURE REFERENCE

101: cell; 601: case; 1011: monomer; 102: bottom plate; 602: side case; 103: top plastic part; 104: plastic part rear cover plate; 1041, 1042 and 1051: output holes; 104: output interface part; 105: input interface part; 106: patch board; 1031: side opening part; 1032: shore; 1071: hole position; 1041: shore; 1033: hole part; 1035: horizontal bearing plate; 6021: first snap-on side case; 6022: second snap-on side case; 301: second slot; 302: second ledge; 201: first slot; 202: first ledge.

### DETAILED DESCRIPTION OF ILLUSTRATED EMBODIMENTS

The following description of the embodiment is offered with attached drawings and the embodiment below is intended to implement according to the technical scheme of the invention, with detailed execution method and operation processes, but is not to limit the protection scope of the invention.

### EXAMPLE 1

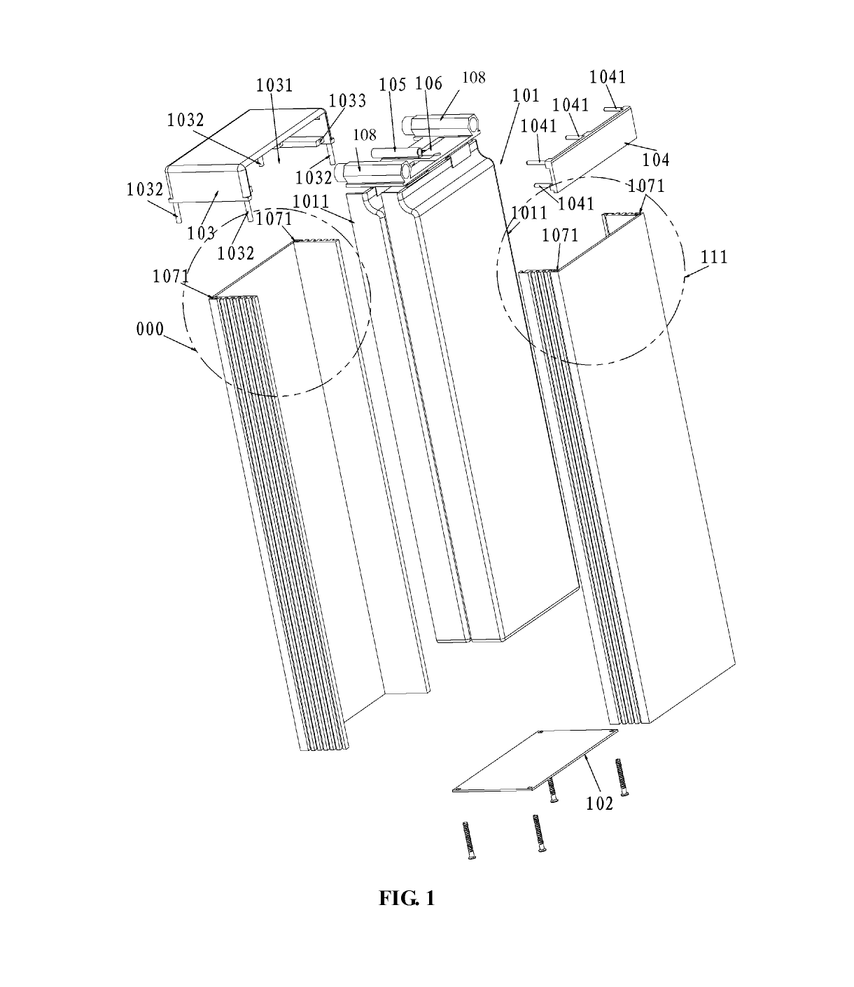

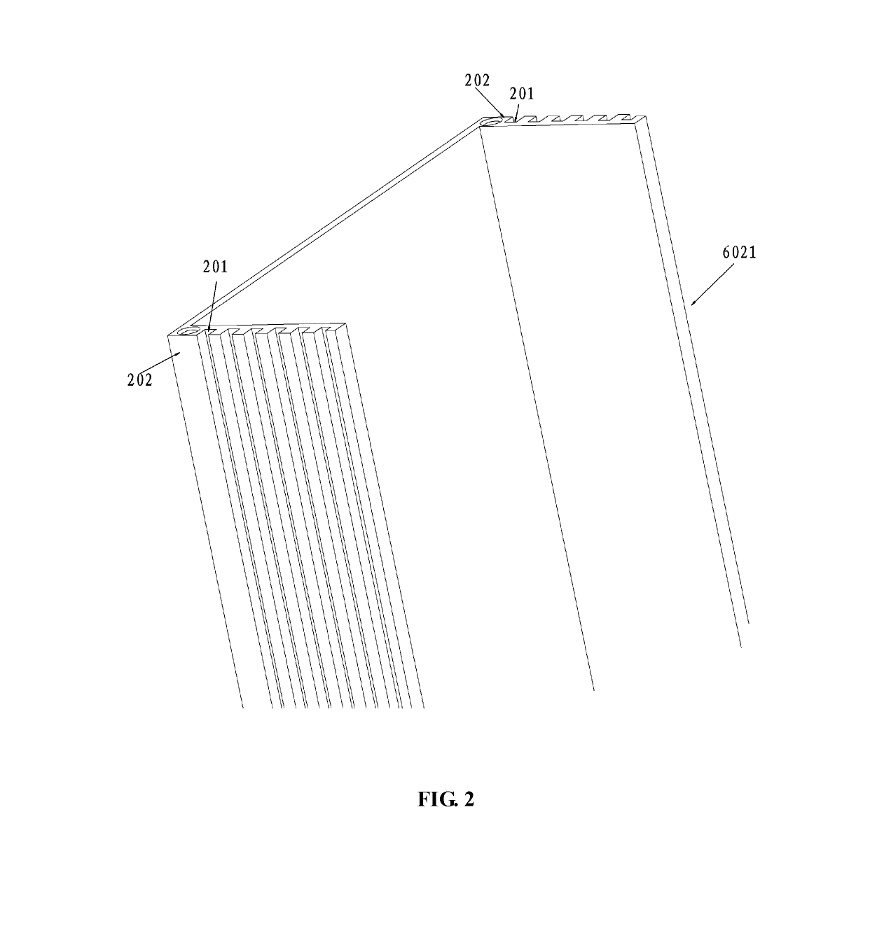

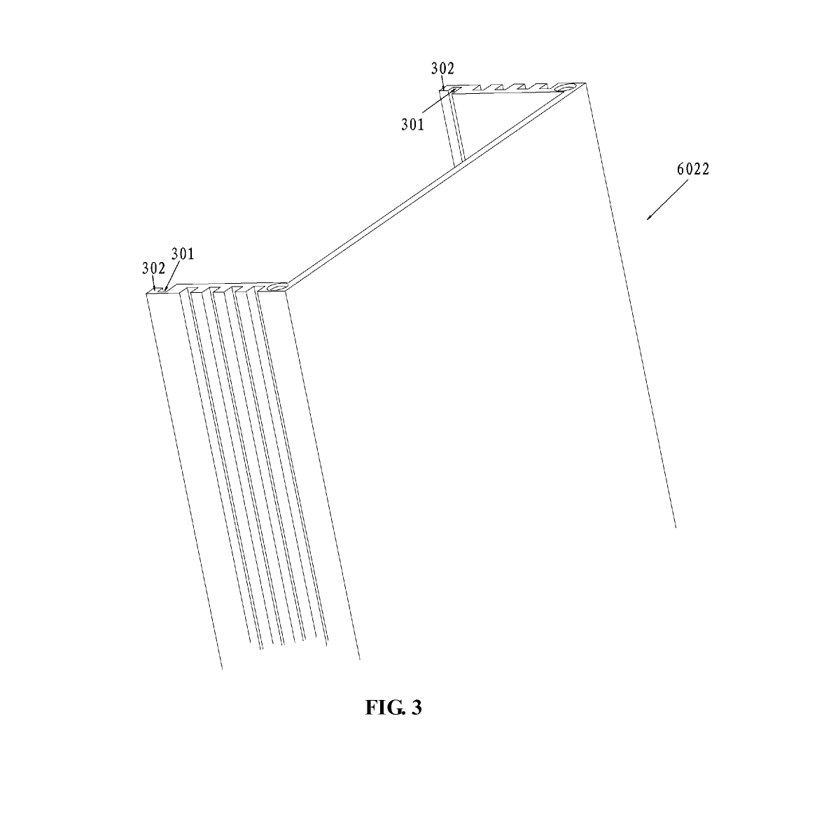

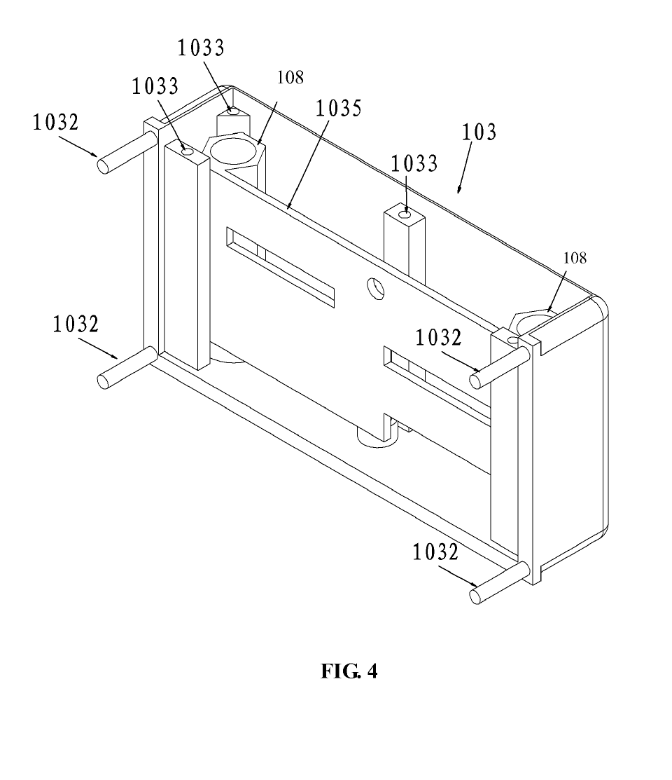

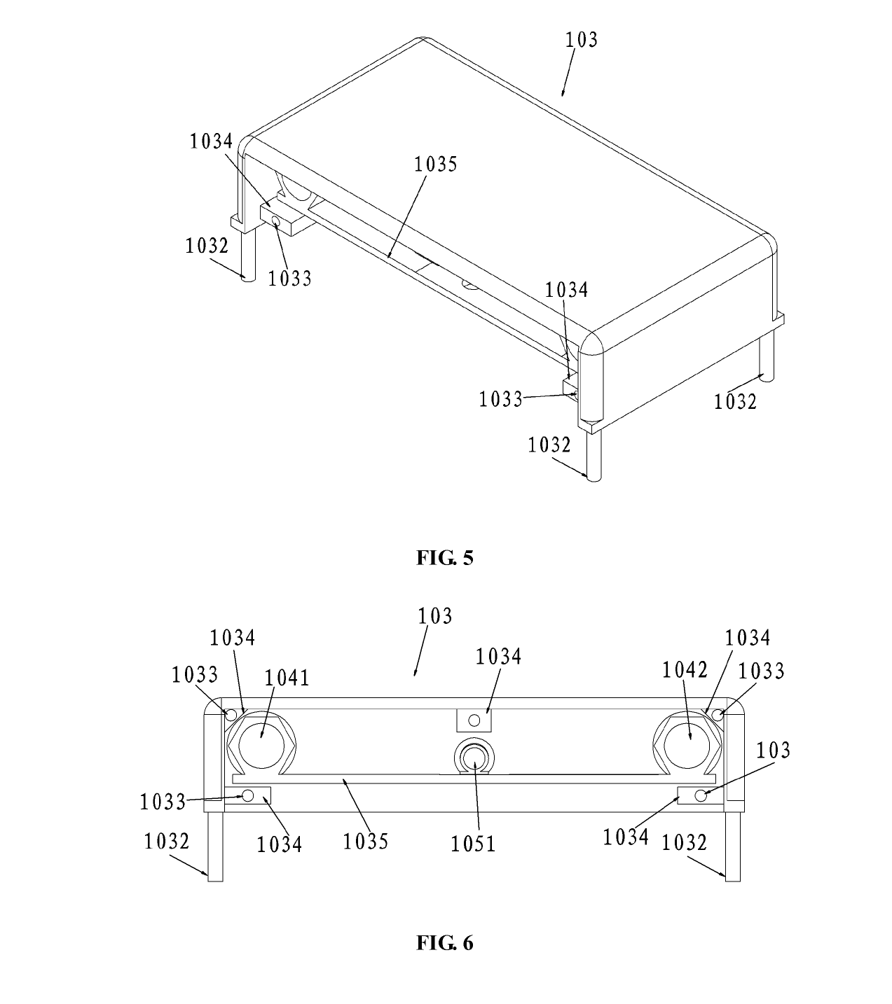

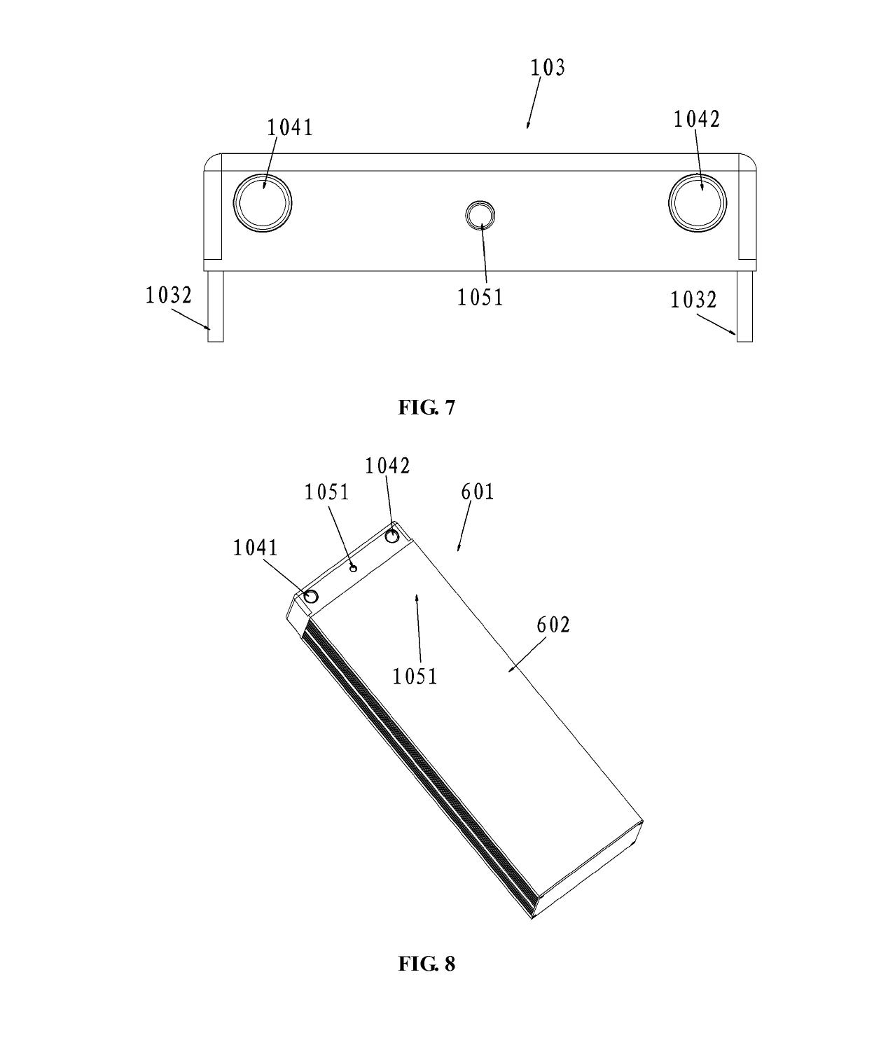

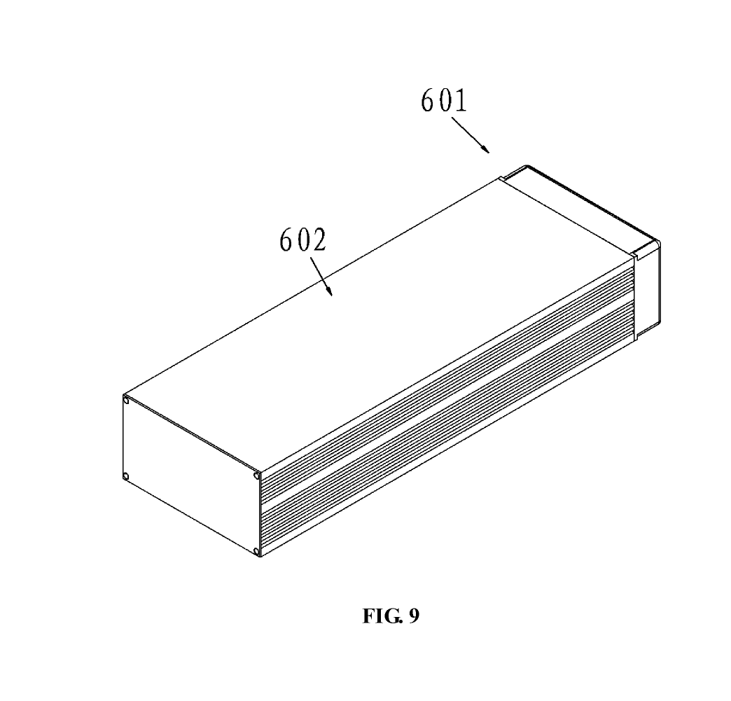

Regarding to FIGS. 1-7, as an embodiment of the present invention, an lithium-ion battery pack for easy installation comprising: a cell 101 and a case 601 packaged outside the cell 101;

Wherein the cell 101 comprising a plurality of lithium-ion battery monomers 1011 which are connected in series or parallel, or any combination thereof.

The case 601 is arranged outside the cell 101 for packaging a plurality of battery monomers 1011 combined together so as to form the cell 101.

Specifically, the case 601 comprising: a bottom plate 102 arranged at the bottom of cell 101, a side case 602, a top plastic part 103, and a plastic part rear cover plate 104.

Wherein the bottom plate 102 is packaged on the bottom of the side case 602, and the side case 602 is packaged at the periphery of four sides, and the battery monomers 1011 are packaged together from the periphery by the side case 602.

The top plastic part 103 is packaged at the top of cell 101.

The plastic part rear cover plate 104 is packaged at a side opening part 1031 of the top plastic part 103.

The cell 101 is packaged by the bottom plate 102, the side case 602, the top plastic part 103 and the plastic part rear cover plate 104, in order to form an integral battery pack.

On the top plastic part 103, the output holes (1041, 1042, 1051) are fixed arranged on the inner wall of the side plate which is directly faced to the side opening part 1031 of the top plastic part 103, an output interface part 108 and an input interface part 105 are cutting through the output holes (1041, 1042, 1051), such that the user may charge the battery pack by inserting or screwing the external lead terminal/power input terminal for achieving the output of power.

The output interface part 108 and input interface part 105 are respectively fixed on a patch board 106, which are electrically connected to the input and output circuits on the patch board 106.

Additionally, a battery protection circuit or control circuit may be further provided on the patch board 106 except the above mentioned parts and lines according to the actual demand.

When it is installed, the following process may be further used but not limited to the following steps:

First, arranging the cell 101 in the side case 602, and plugging the bottom plate 102 at the bottom opening of side case 602, so as to make the bottom plate 102 is plugged and fixed at the bottom opening of side case 602. Furthermore, the top plastic part 103 is assembled to the top opening of the side case 602. In the embodiment of present invention, since a horizontal side of the top plastic part 103 is configured as an opening (which is recorded as the side opening part 1031 in the present invention), the installing operation of the circuit connection of the cell 101 can be convenient presented at the position of side opening 1031 after assembling the top plastic part 103, for example but not limited to: the output interface part 108 and input interface part 105 are respectively welding connected to each circuit wiring on the patch board 106.

After circuit connection is completing, plugging and fixing the plastic rear cover plate 104 to the side opening part 1031 of the top plastic part 103.

One or a plurality of vertical hole positions 1071 is arranged on the top of side case 602 in the embodiment of the present invention, correspondingly, one or a plurality of vertical shore 1032 is arranged on the bottom of the top plastic part 103 located at the top of side case 602, each shore 1032 and vertical hole position 1071 are adapted each other. When it is connected, the shores 1032 arranged on the bottom of top plastic part 103 are respectively inserted into the corresponding vertical hole positions 1071 on the side case 602, until the bottom edge of top plastic part 103 is tight coupled to the top edge of side case 602, so as to achieve a tight coupling of the side case 602 and the top plastic part 103.

In addition, on the plastic rear cover plate 104, at least two extended shores 1032 are arranged on one side of side opening part 1031 which is toward to the side of top plastic part 103, and at least two horizontal hole parts 1033 are correspondingly arranged in the top plastic part 103. When each of the horizontal shores 1032 of the plastic part rear cover plate 104 are respectively inserted into each of the horizontal hole parts 1033 of the top plastic part 103, the plastic part rear cover plate 104 is packaged at the side opening part 1031 of the top plastic part 103, thereby tightly sealing the side opening part 1031 of the top plastic part 103.

As described above, in the embodiment of the present invention, the case 601 of battery pack comprises: a bottom plate 102, a side case 602, a top plastic part 103 and a plastic part rear cover plate 104. With respect to a structure of the square chamber with a plate in the prior art, it is more convenient for the installation of battery pack in the embodiment of present invention, which is beneficial to improve the efficiency of assembly technology during production.

Moreover, in the embodiment, the side case 602 is snap-on connected to the bottom of top plastic part 103 via the hole positions 1071 and shores 1032, and the top plastic part 103 is snap-on connected to the plastic rear cover plate 104 via the hole parts 1033 and shores 1032 for each part of the case 601 can be assembled in a more convenient way, which is apt to positionable mounting, and further improving the assembly efficiency; additionally, it is avoided to produce scratches or defective products with the screw insertion by using of screw fastening.

In addition, in the embodiment, the hole position 1071 is arranged in the length direction of the side case 602 with a longer edge length, not on the top plastic part 103 with a relative shorter edge length. Accordingly, the hole part 1033 is arranged on the top plastic part 103 with a longer edge length, not on the plastic rear cover plate 104 with a relative shorter edge length. As described above, it is beneficial for the arrangement of hole positions/parts (1071,1033), and the hole positions/parts (1071, 1033) are arranged to be more deeper so as to improve the adapted depth with the corresponding shores 1032, which makes the connection to be firmer and not easily displacing or falling apart.

Furthermore, in the embodiment, when it is assembled, after placing the cell 101 in the chamber of the side case 602, the top of cell 101 is connected through the top opening of the side case 602, and each monomer 1011 of the cell 101 is circuit connected to the circuit, that is the series-parallel connection of each monomer 101, and the lead connection of input and output circuit; then, assembling the top plastic part 103 on the top of cell 101, and the connection of circuit and each output/input interface parts (108, 105) is presented through the side opening part 1031 of the top plastic part 103, so that the operation is more convenient and further improve the working efficiency.

In the embodiment, preferably but not limited to using a metal side case 602, so that the heat produced by the cell 101 will be effectively dissipated to the external environment by the side case 602 which is contacted with the cell 101 with a largest contact area, that is beneficial for improving the heat dissipation rate of the cell 101, particularly for the high-rate battery pack.

In the embodiment, preferably but not limited to using a metal bottom plate 102, so that the heat produced by the cell 101 will be effectively dissipated to the external environment by the bottom plate 102 which is contacted with the cell 101, which is beneficial for improving the heat dissipation rate of the cell 101, particularly for the high-rate battery pack.

It should be demonstrated that the connection of bottom plate 102 and side case 601 in the embodiment of present invention may use the screw fastening connection as shown in FIG. 1, which may also refer to the inserted fastening way of the shores and hole parts which are arranged between the side case 602 and the top plastic part 103.

In the embodiment, since the top plastic part 103 and plastic rear cover plate 104 are insulated, it can be selected a metal tube as the output interface part 108 or input interface part 105, said metal tube has a large cross section and a throughout hole or trepanning arranged thereon, and the output interface part 108 and input interface part 105 are directly penetrating a side wall of the top plastic part 103. This connection is convenient for the installation of connection, and also beneficial to guarantee the electrical safety.

As an application of the embodiment in the present invention, there are four hole positions 1071 arranged on the top of side case 602, correspondingly, the number of shore 1032 arranged at the bottom of top plastic part 103 is four, so that the connection of side case 602 and top plastic part 103 is positioning fastened at four corners for a better tight and fasten connection.

As an application of the embodiment, the number of hole parts 1033 arranged on the top plastic part 103 can be but not limited to five. The hole part 1033 is configured in detailed as below: five straight arris 1034 which is vertical to the side opening part 1031 are respectively arranged in the side of inner chamber of top plastic part 103, wherein four of straight arris 1034 are arranged at the inner side of four corners of the top plastic part 103, the remaining straight edge 1034 is arranged at the central of top plate of the top plastic part 103, and the hole parts 1033 mentioned above are respectively arranged on the five straight arris 1034. Accordingly, there are five shores 1032 arranged at the plastic rear cover plate 104, which are correspondingly inserted into each hole part 1033 at the top plastic part 103. Thus, the connection of the top plastic part 103 and the plastic rear cover plate 104 is achieved by positionable fastening at the four corners and central of inner side of one side, so that the connection will be tighter and firmer.

In the embodiment, a horizontal bearing plate 1035 protruded or extended horizontally along the inner side of side plate can be further provided on the inner side of side plate faced to the side opening part of the top plastic 103, thereby the input interface part 105 and output interface part 108 of first side panel fastened on the top plastic part 103 are fixed on the upper surface of the horizontal bearing plate 1035, such that the horizontal bearing plate 1035 for bearing weight is located on the bottom of the output and input interface parts (108, 105). Therefore, it is convenient for the installing and positioning of the output and input interface parts (108, 105); on the other hand, it benefits to avoid that the output and input interface parts (108, 105) are displaced by inserting and extracting of the input and output terminals, which is further to ensure a firm and durable structure; wherein the output and input interface parts (108, 105) are fixed on the upper surface of the horizontal bearing plate 1035 at the top plastic part 103 via screw fastening, glue bonding or the like.

Moreover, as a further application example of the embodiment in the present invention, which can be but not limited to that there are six shores 1032 arranged on the plastic rear cover plate 104, and four shores 1032 are located at the edge corner of the plastic rear cover plate 104, the rest of two shores 1032 are arranged in the middle part in length direction of the rear cover plate; correspondingly, there may be six hole parts 1033 arranged on the corresponding positions of the top plastic part 103, wherein four of the hole parts 1033 are located at the inner side of four corners of the top plastic part 103, the rest of two hole parts 1033 are arranged at the internal middle part in length direction of the top plastic part 103. The six shores 1032 and the hole parts 1033 are hided inside after the shores 1032 and the hole parts 1033 are adapted each other, and the edges of top plastic part 103 and the plastic rear cover plate 104 are closely fit together, so as to form a firmer assembled structure.

Furthermore, in the embodiment, the side case 602 of the battery pack can be further configured as a snap-on connected structure, and the side case 602 comprises a first snap-on side case 6021 and a second snap-on side case 6022. One side of the first and second side cases (6021, 6022), and two opposite ends are slot-like, the slot-like openings of the first and second snap-on side cases (6021, 6022) are respectively faced each other and snap-on connected together, so as to form a side case 602 with the top and bottom openings.

The top surface of first snap-on side case 6021 is covered on the outer surface of first side of the cell 101, and the two sides of first snap-on side case 6021 are covered on the cell 101, the upper surface of a third side which is adjacent to the first side, and the upper surface of a fourth side; the top surface of second snap-on side case 6022 is covered on the outside the second side of the cell 101, wherein the second side is opposite to the first side; both sides of the second snap-on side case 6022 are respectively covered on the cell 101, the rear surface of third side which is adjacent to the first side, and the rear surface of the fourth side; the first snap-on side case 6021 and the second snap-on side case 6022 are up-and-down relatively connected at the edge of the third and fourth sides of the cell 101, such that a cylindrical side case is formed by the slot-like first and second snap-on side cases (6021, 6022) directly faced each other are up-and-down relatively connected at the slot-like openings. The cell 101 is fixed mount on the space formed by the first snap-on side case 6021 and the second snap-on side case 6022. Through the above structure, when assembling the cell 101, it is convenient for arranging the cell 101 from the slot-like opening into one of the first and second snap-on side cases (6021, 6022), and then assembling the another piece of side case into the snap-on side case which the cell 101 has been arranged therein, the position of slot-like openings are up-and-down relatively connected, so that the cell 101 is conveniently packaged between the first snap-on side case 6021 and second snap-on side cases.

The connection of the first snap-on side case 6021 and second snap-on side case 6022 can be in detailed as:

A first snap-on part is respectively arranged on both edges of slot-like opening of the first snap-on side case 6021; and a second snap-on part is respectively arranged on both opening edges of slot-like opening of the second snap-on side case 6022; two first snap-on parts of the first snap-on side case 6021 are respectively snap-on connected to both second snap-on parts of the second snap-on side case 6022, and the first snap-on side case 6021 and the second snap-on side case 6022 are jointed together to form the side case 602.

Wherein the first snap-on part located on the edges at both sides of the opening of the first snap-on side case 6021 may preferably but not limited to be arranged continuously along the edge of the first snap-on part, whose length is the same as the edge in length direction.

Similarly, the second snap-on part may preferably but not limited to be arranged continuously along the edge of the second snap-on part, whose length is the same as the edge in length direction.

As shown in FIG. 1, a first slot 201 and a first ledge 202 are provided on the outer surface of both sides of the opening on the first snap-on side case 6021(both of which constitutes the first snap-on part); wherein the length of first slot 201 is the same as first snap-on side case 6021, and the first ledge 202 is located outside the first slot 201.

Similarly, a second slot 301 and a second ledge 302 are provided on the outer surface of both sides of the opening on the second snap-on side case 6022 (both of which constitute the second snap-on part); wherein the length of first slot 301 is the same as first snap-on side case 6022, and the first ledge 302 is located outside the first slot 301.

During installing, both of the first ledge 202 at the sides of opening of the first snap-on side case 6021 are respectively slide from the end into both of second slots 301 of the second snap-on side case 6022, until the first snap-on side case 6021 and the second snap-on side case 6022 are directly faced each other. By the use of this connection, the installation is convenient and easy, and achieves an accurate and fast positioning

In the embodiment, a heat-dissipated ledge may be further provided on each outer surface of the first snap-on side case 6021 and the second snap-on side case 6022; or which can be arranged on the outer surface of both sides of opening at the second snap-on side case 6022; or the outer surface of all sides opposite to the opening at the first snap-on side case 6021 and the second snap-on side case 6022. It can be further improved the heat dissipation of side case 602 which has a larger contact area with the cell 101, so as to enhance the heat dissipation of the battery pack for increasing service life of the lithium-ion battery pack.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A lithium-ion battery pack for easy installation, comprising: a cell and a case packaged outside the cell;
the case comprising: a bottom plate, a side case, a top plastic part and a rear cover plate;
two opposite ends of the side case are provided as opening, the cell is packaged in the side case, the bottom plate is packaged at the bottom of the side case, the top plastic part is fixed on the top of the side case, and the plastic part rear cover plate is packaged at the side opening part of the top plastic part;
at least one hole position is arranged on the top of the side case, at least a shore is arranged on the bottom of the top plastic part, each said shore of the top plastic part is respectively inserted into each said hole position of the side case, and the bottom edge of the top plastic part is jointed to the top edge of the side case;
on the top plastic part, an output interface part and an input interface part are arranged on the inner side of the side plate which is directly faced to the side opening part of the top plastic part, the output interface part and input interface part are respectively circuit fixed on a patch board which is electrically connected to the input and output circuits of the cell;
at least two extended shores are arranged on the plastic rear cover plate, and at least two horizontal hole parts are arranged on the top plastic part; each said shore of the plastic part rear cover plate is inserted into each said hole part of the top plastic part, and the plastic part rear cover plate is packaged on the side opening part of the top plastic part.

2. The lithium-ion battery pack for easy installation according to claim 1, wherein:
four hole positions are arranged at the top of the side case, each said hole position is located at the top of four corner edges of the side case;
four shores are arranged at the bottom of the top plastic part, each said shore is located at the bottom of four corner edges of the top plastic part; and
a shore is extended at each bottom of four corner edges of the top plastic part.

3. The lithium-ion battery pack for easy installation according to claim 1, wherein:
five said hole positions are arranged on the top plastic part,
five straight arris which is vertical to the side opening part are respectively arranged on the inner chamber of the top plastic part, wherein four of straight arris are arranged at the inner side of four corners of the top plastic part, the rest of straight arris is arranged in the middle of top plate of the top plastic part,
five said hole positions are arranged at the end of five straight arris;
five shores are provided on the plastic rear cover plate,
four said shores are respectively arranged at the inner side of four corners of the plastic rear cover plate, and the rest of shore is located in the middle of the edge at length direction of the rear cover plate.

4. The lithium-ion battery pack for easy installation according to claim 1, wherein:
the side case is composed of a first snap-on side case and a second snap-on side case,
the first snap-on side case and second snap-on side case are slot-like,
the slot-like openings of the first snap-on side case and second snap-on side case are directly faced to the side case which is formed by snap-on connection.

5. The lithium-ion battery pack for easy installation according to claim 1, wherein:
the slot-like openings of the first snap-on side case and second snap-on side case are directly faced to the side case which is formed by snap-on connection, which is in detailed as following:
a first snap-on part is respectively arranged on both opening edges of slot-like opening of the first snap-on side case;
a second snap-on part is respectively arranged on both opening edges of slot-like opening of the second snap-on side case,
the first snap-on part and the second snap-on part may be engaged to each other.

6. The lithium-ion battery pack for easy installation according to claim 5, wherein each of the first snap-on part and the second snap-on part is continuously along the edge in length direction of the first snap-on side case and the second snap-on side case, whose length is the same as the edge in length direction.

7. The lithium-ion battery pack for easy installation according to claim 6, wherein:
a first slot and a first ledge are respectively arranged on the outer surface of both side edges of the slot-like opening of the first snap-on side case, wherein on each side, the first ledge is located outside the first slot, and the first slot and the first ledge are composed the first snap-on part;
a second slot and a second ledge are respectively arranged on the inner side of both side edges of the slot-like opening of the second snap-on side case, wherein on each side, the second ledge is located outside the second slot, and the second slot and the second ledge are composed the second snap-on part;
the slot-like openings of the first snap-on side case and the second snap-on side case are directly faced to the side case formed by the snap-on connection, which is in detailed as:
each said first ledge of the first snap-on side case is inserted into each said second slot of the second snap-on side case;
each said second ledge of the second snap-on side case is inserted into each said first slot of the first snap-on side case.

8. The lithium-ion battery pack for easy installation according to claim 4, wherein a heat-dissipation ledge is provided on the outer surface of at least one side of the first snap-on side case and the second snap-on side case.

9. The lithium-ion battery pack for easy installation according to claim 1, wherein the side case is a metal side case; and/or the bottom plate is a metal bottom plate.

10. The lithium-ion battery pack for easy installation according to claim 1, wherein a horizontal bearing plate is arranged at inner side of the side plate directly faced to the side opening part on the top plastic part, and the output interface part and the input interface part are fixed on the upper surface of the horizontal bearing plate.

11. The lithium-ion battery pack for easy installation according to claim 5, wherein a heat-dissipation ledge is provided on the outer surface of at least one side of the first snap-on side case and the second snap-on side case.

12. The lithium-ion battery pack for easy installation according to claim 6, wherein a heat-dissipation ledge is provided on the outer surface of at least one side of the first snap-on side case and the second snap-on side case.

13. The lithium-ion battery pack for easy installation according to claim 2, wherein a horizontal bearing plate is arranged at inner side of the side plate directly faced to the side opening part on the top plastic part, and the output interface part and the input interface part are fixed on the upper surface of the horizontal bearing plate.

14. The lithium-ion battery pack for easy installation according to claim 3, wherein a horizontal bearing plate is arranged at inner side of the side plate directly faced to the side opening part on the top plastic part, and the output interface part and the input interface part are fixed on the upper surface of the horizontal bearing plate.

15. The lithium-ion battery pack for easy installation according to claim 4, wherein a horizontal bearing plate is arranged at inner side of the side plate directly faced to the side opening part on the top plastic part, and the output interface part and the input interface part are fixed on the upper surface of the horizontal bearing plate.
